(19) United States
(12) Patent Application Publication
(10) Pub. No.: US 2008/0079821 A1
(43) Pub. Date: Apr. 3, 2008

(54) Camera, lens unit, and camera main body

(76) Inventors: Hideki Nagata, Hachioji-shi (JP); Minoru Omaki, Kunitachi-shi (JP)

Correspondence Address: KENYON & KENYON LLP, ONE BROADWAY, NEW YORK, NY, 10004, US

(21) Appl. No.: 11/903,894

(22) Filed: Sep. 24, 2007

(30) Foreign Application Priority Data
Sep. 29, 2006 (JP) 2006-267378

(51) Int. Cl. H04N 5/76; H04N 5/225

(52) U.S. Cl. 348/231.99; 348/335; 348/E05.024; 348/E05.031

(57) ABSTRACT

To provide a camera and a lens unit that can easily obtain image data subjected to predetermined filtering processing. A camera includes a camera main body, a lens unit having an photographing optical system that forms an image of a subject, image pickup means that captures the image of the subject and converts the captured image into electrical image information, an algorithm storing unit that stores a predetermined image processing algorithm, and image processing means that performs image processing of the image information on the basis of the image processing algorithm. The algorithm storing unit is arranged to the lens unit, and the lens unit and the algorithm storing unit are detachably attached to the camera main body

### BACKGROUND OF THE INVENTION

1. Field of the Invention

The present invention relates to a camera, a lens unit, and a camera main body.

This application is based on Japanese Patent Application No. 2006-267378, the content of which is incorporated herein by reference.

2. Description of Related Art

Recently, a so-called digital camera having an image pickup device, such as a CCD (Charge Coupled Device), arranged in a camera main body is widespread (refer to, e.g., Japanese Unexamined Patent Application, Publication No. 11-112859).

The camera having the image pickup device generally comprises an image processing CPU (Central Processing Unit) that performs image processing, e.g., filtering processing and correction processing, of image data obtained by the image pickup device. The image processing is normally executed on the basis of a predetermined image processing algorithm. Further, the image data is subjected to the image processing with the image processing CPU on the basis of optical characteristics of a lens unit attached to the camera. Therefore, in the case of an interchangeable lens that is detachably attached to the camera main body, desired filtering processing and correction processing with high precision needs an image processing algorithm for differing the image processing with the image processing CPU depending on the optical characteristics of lens units every time for exchanging the lens units.

Further, in recent years, the compact size of the camera is required in the market and the reduction in size of the lens unit as well as the camera main body is necessary. The reduction in size of the lens unit needs to decrease the number of lens pieces of the lens unit. In this case, the combination of lenses cannot optically correct the generation of various abbreviations due to the optical characteristics peculiar to the lens unit. Therefore, if the image processing corrects various abbreviations of the small lens unit, complicated calculation processing with the image processing CPU is required. Furthermore, the correction processing of all of the plurality of interchangeable lenses results in a complicated image processing algorithm therefor.

In general, the image data captured by this camera is subjected to filtering processing, such as sepia tone processing and cross-screen processing, with image processing software. The image processing software can execute a plurality of filtering processing of the image data, and image processing software operated on a personal computer (hereinafter, referred to as a PC) is well-known.

### BRIEF SUMMARY OF THE INVENTION

According to the first aspect of the present invention, a camera comprises:

a camera main body;

a lens unit having an photographing optical system that forms an image of a subject;

image pickup means that captures the image of the subject and converts the captured image into electrical image information;

an algorithm storing unit that stores a predetermined image processing algorithm; and

image processing means that performs image processing of the image information on the basis of the image processing algorithm.

The algorithm storing unit is arranged to the lens unit, and

the lens unit and the algorithm storing unit are detachably attached to the camera main body.

According to the second aspect of the present invention, a lens unit that is detachably attached to a camera main body, comprises:

a photographing optical system that forms an image of a subject to image pickup means arranged to the camera main body; and

an algorithm storing unit that stores a predetermined image processing algorithm used for image processing of image information obtained by the image pickup means.

According to the third aspect of the present invention, a camera main body comprises:

a casing; and

image pickup means that captures an image of a subject and converts the image into electrical image information,

wherein the lens unit is detachably attached to the casing.

In this case the lens unit comprising:

a photographing optical system that forms an image of a subject to image pickup means arranged to the camera main body; and

an algorithm storing unit that stores a predetermined image processing algorithm used for image processing of image information obtained by the image pickup means.

### BRIEF DESCRIPTION OF THE SEVERAL VIEWS OF THE DRAWINGS

FIG. 1 is a block diagram for illustrating the entire s of a camera;

FIG. 2 is a flowchart for illustrating the structure of the camera shown in FIG. 1;

FIG. 3 is a block diagram for illustrating the entire structure of a camera according to a modification; and

FIG. 4 is a flowchart for illustrating operation of the camera shown in FIG. 3.

### DETAILED DESCRIPTION OF THE INVENTION

A camera according to the present invention comprises: a camera main body; a lens unit having a photographing optical system that forms an image of a subject; image pickup means that captures the image of the subject and converts the captured image into electrical image information; an algorithm storing unit that stores a predetermined image processing algorithm; image processing means that performs image processing of the image information on the basis of the image processing algorithm. Further, the algorithm storing unit is arranged to the lens unit, and the lens unit and the algorithm storing unit are detachably attached to the camera main body.

With the camera, a predetermined image processing algorithm is stored to the algorithm storing unit and the lens unit is therefore selected, thereby performing desired image processing of the image information.

For example, upon storing different image processing algorithms to the algorithm storing units of a plurality of the lens units, the lens unit to be attached to the camera main body is exchanged, thereby performing the image processing of the image information with different image processing algorithms. As a result, the image subjected to a plurality of different image processing can be obtained without storing a plurality of different image processing algorithms to the camera main body.

Further, the selection of the lens unit to be exchanged results in selecting the image processing algorithm. Therefore, as compared with a method for selecting the image processing algorithm with a change-over switch disposed to the camera main body, operation for selecting the image processing algorithm is simple and visceral or sensuous selecting operation is possible.

Preferably, with the camera, the algorithm storing unit stores the image processing algorithm peculiar to the lens unit.

With the camera, the image processing algorithm peculiar to the lens unit is stored to the algorithm storing unit, thereby obtaining the image of the subject undergoing the image processing with the image processing algorithm peculiar to the lens unit used for the image capturing without storing the image processing algorithms peculiar to all lens units that can be attached to the camera main body to the camera main body.

Preferably, with the camera, the algorithm storing unit stores an algorithm for correction processing of optical characteristics peculiar to a photographing optical system.

With the camera, the algorithm storing unit stores the algorithm for correction processing of optical characteristics peculiar to the photographing optical system, thereby obtaining the image of the subject undergoing the image processing with the algorithm for correction processing of the optical characteristics peculiar to the photographing optical system used for image capturing without storing the algorithm for correction processing of the optical characteristics peculiar to the photographing optical system of all lens units that can be attached to the camera main body.

Preferably, with the camera, the algorithm storing unit stores an algorithm for creating a special effect to create the special effect.

With the camera, the image processing means stores an algorithm for creating a special effect to create a predetermined special effect and the special effect given to the image information is consequently selected by selecting and exchanging the lens unit. As a result, the image subjected to a plurality of different special effects can be obtained without storing a plurality of algorithms for creating the special effect to the camera main body.

Further, the lens unit to he exchanged is selected, thereby selecting the algorithm for creating the special effect. As a consequence, as compared with the method for selecting the algorithm for creating the special effect with a change-over switch disposed to the camera main body, operation for selecting the algorithm for creating the special effect is easy and visceral or sensuous selecting operation is possible.

Incidentally, the above-mentioned special effect can include filtering processing such as chroma emphasis, edge emphasis, drawing with softness (soft focus), sepia processing, cross-screen processing, and mirage processing.

Preferably, with the camera, the image pickup processing means performs image processing with information on optical characteristics peculiar to the photographing optical system of the lens unit, thereby obtaining special effects.

With the camera, the image processing means performs the special effect using various abbreviations due to the optical characteristics of the photographing optical system of the image information. For example, upon performing the special effect similar to the effect due to various abbreviations to the image information, the image processing means performs image processing for emphasizing or reducing the effects due to various abbreviations on the basis of peculiar optical characteristics. As a consequence, the load of calculation processing with the image processing means can be reduced.

On the other hand, upon performing the special effect different from the effects due to various abbreviations to the image information, the image processing means removes various abbreviations on the basis of the peculiar optical characteristics and thereafter performs the special effect to the image information. As a consequence, the special effect advantageous for the image information can be accomplished.

Preferably, with the camera, a predetermined abbreviation is applied to optical characteristics of the photographing optical system.

With the camera, abbreviations such as blur or distortion are caused in the image of the subject formed to the image pickup means by the photographing optical system, and a predetermined special effect due to abbreviations is obtained. The predetermined special effect is obtained with the abbreviations, thereby reducing the load of the image processing with the image processing means.

Preferably, with the camera, the special effect is obtained by executing the filtering processing.

With the camera, the image processing means performs the filtering processing to the image information, thereby executing the image processing to obtain the special effect. Since the image processing means is disposed to the lens unit, the lens unit is selected, thereby selecting whether or not the filtering processing is performed to the image information. Further, the image information is subjected to predetermined filtering processing.

Incidentally, the filtering processing can obtain effects due to, e.g., chroma emphasis, edge emphasis, drawing with softness (soft focus), sepia processing, cross-screen processing, and mirage processing.

The lens unit according to the present invention is detachably attached to the camera main body. The lens unit comprises the photographing optical system that forms the image of the subject to the image pickup means arranged to the camera main body, and the algorithm storing unit that stores a predetermined image processing algorithm used for image processing of the image information obtained by the image pickup means.

With the lens unit, the algorithm storing unit is disposed to the lens unit, thereby storing a predetermined image processing algorithm used for image processing of the image information obtained by the image pickup means to the algorithm storing unit. Further, the lens unit is attached/detached to/from the camera main body, thereby integrally attaching/detaching the algorithm storing unit arranged to the lens unit and the photographing optical system.

For example, if the predetermined image processing algorithm is an image processing algorithm for optical characteristics of the photographing optical system arranged to the lens unit and of the algorithm storing unit, the photographing optical system and the image processing algorithm are integrally arranged to the lens unit. Therefore, all image processing algorithms corresponding to the lens units that can be attached do not need to be stored to the camera main body.

Alternatively, if the predetermined image processing algorithm is an image processing algorithm for a special effect of the filtering processing to the image information, the lens unit is attached to the camera main body, thereby performing image processing having desired special effects to the image information. Therefore, a plurality of the image processing algorithms for the special effects do not need to be stored to the camera main body. Further, as compared with the method for selecting the image processing algorithm for the special effect with a mode change-over switch arranged to the camera main body, operation for selecting the image processing algorithm is easy and visceral or sensuous selecting operation is performed.

Preferably, with the lens unit, a predetermined image processing algorithm is a filtering algorithm.

With the lens unit, the filtering algorithm is stored to the algorithm storing unit, and image processing for executing the filtering processing to the image information is therefore performed. As a consequence, the selection of the lens unit results in selecting whether or not the image information is subjected to the filtering processing. Further, the selection of the lens unit to be exchanged enables predetermined filtering processing to the image information.

Incidentally, as a consequence of the filtering processing, advantages due to chroma emphasis, edge emphasis, drawing with softness (soft focus), sepia processing, cross-screen processing, and mirage processing can be obtained.

The camera main body according to the present invention comprises: a casing; and image pickup means that captures an image of a subject and converts the image into electrical image information. Any of the lens units is detachably attached to the casing.

With the lens unit, the image processing of the image information obtained by the image pickup means is performed on the basis of the image processing algorithm stored in the algorithm storing unit in any of the lens units attached to the casing. Therefore, upon exchanging the lens unit, the image processing algorithm corresponding to the photographing optical system after the exchange, necessary for the image processing, does not need to be stored to the camera main body, and the image processing algorithm does not need to be input to the camera main body.

With the camera, the lens unit, and the camera main body, the algorithm storing unit and lens unit are attached/detached to/from the camera main body. Therefore, advantageously, predetermined filtering processing is performed without the load for storing many image processing algorithms to the image processing means on the side of the camera main body.

### First Embodiment

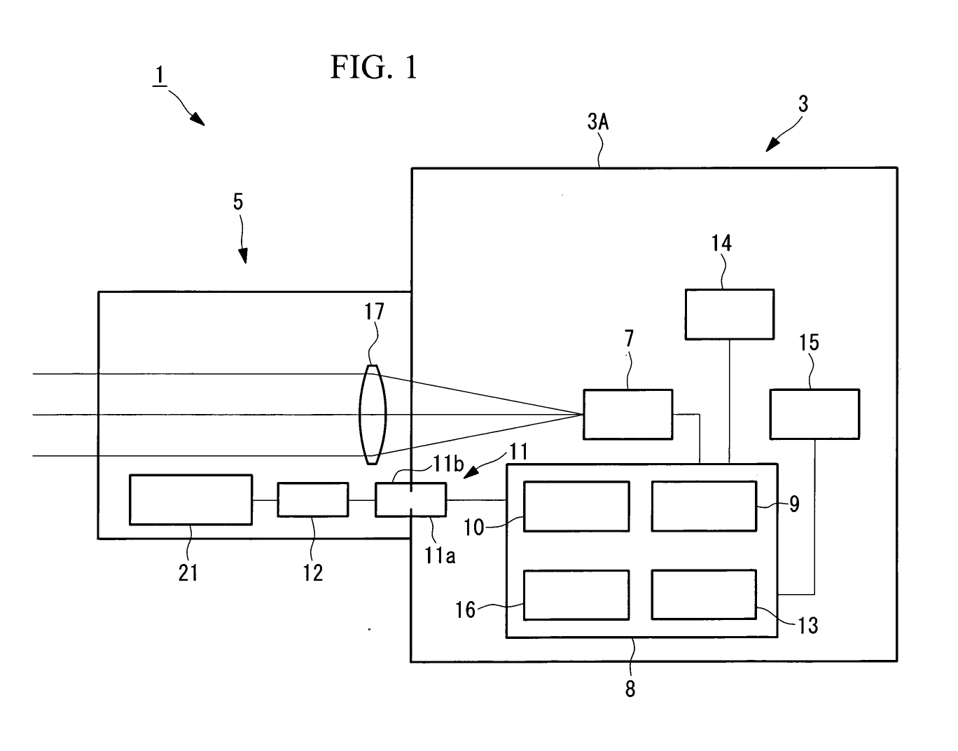

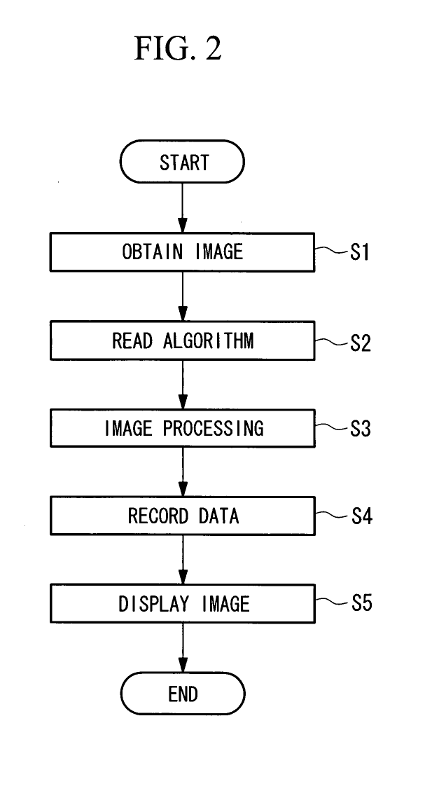

Hereinbelow, a description will be given of a camera with reference to FIGS. 1 and 2.

FIG. 1 is a block diagram for illustrating the entire structure of the camera.

A camera 1 is a digital camera that captures an image of a subject with an image pickup device such as a CCD.

Referring to FIG. 1, the camera 1 comprises a camera main body 3 and a lens unit 5.

The lens unit 5 is detachably attached to a casing 3A of the camera main body 3, which will be described later, via a well-known attaching/detaching mechanism. Various types of lens units 5 having different focusing distances can be attached to the casing 3A.

The camera main body 3 includes an image pickup device 7 that captures the image of the subject, and the lens unit 5 is detachable to the camera main body 3. As shown in FIG. 1, the camera main body 3 comprises: the casing 3A; an image pickup device (image pickup means) 7; a control unit 8 on the main body side; a first communication unit 11a; and a display unit (display means) 15.

The casing 3A forms the exterior of the camera main body 3, and accommodates the image pickup device 7, the control unit 8 on the main body side, the first communication unit 11a, and the display unit 15.

The image pickup device 7 creates an image pickup signal (electrical image information) on the basis of the image of the subject formed to the image pickup device 7. The image pickup device 7 is arranged to the position for forming the image of the subject condensed by the lens unit 5 onto the image pickup device 7. The image pickup signal output from the image pickup device 7 is input to a signal processing circuit 9 in the control unit 8 on the main body side. Incidentally, as the image pickup device 7, a well-known image pickup device such as a CCD or a CMOS (Complementary Metal Oxide Semiconductor) is used and the image pickup device 7 is not limited to those.

The control unit 8 on the main body side comprises: the signal processing circuit 9; an image processing unit (image processing means) 10; a display image signal processing unit 13: and a memory 16. Further, an input unit 14 is arranged to the control unit 8 on the main body side.

The signal processing circuit 9 performs signal processing, such as analog/digital conversion processing, to the image pickup signal output from the image pickup device 7, thereby creating the image data. The image pickup signal is input to the signal processing circuit 9 from the image pickup device 7. The image data subjected to the signal processing by the signal processing circuit 9 is output to the image processing unit 10.

The image processing unit 10 performs image processing to the image data on the basis of a filtering algorithm. The image pickup data is input to the image processing unit 10 from the signal processing circuit 9, and the filtering algorithm is input from the first communication unit 11a. The image data after the image processing is output to the memory 16 from the image processing unit 10.

The image processing executed by the image processing unit 10 includes image processing for correcting optical characteristics (various abbreviations) peculiar to a lens system 17, image processing (Photoshop (registered trademark of Adobe Systems Incorporated), filtering processing for special effects (chroma emphasis, edge emphasis, drawing with softness (soft focus)), sepia processing, cross-screen processing, and mirage processing. Further, according to the first embodiment, the image processing unit 10 may execute the image processing without using various abbreviations due to the optical characteristics of the lens system 17, and alternatively, may perform the image processing with various abbreviations. The image processing unit 10 is not limited to those.

Incidentally, as the image processing unit 10, a well-known calculating unit, such as a CPU or a DSP (Digital Signal Processor) can be used and the image processing unit 10 is not limited to those.

The display image signal processing unit 13 performs signal processing of the image data after the image processing and creates image display data. The display image signal processing unit 13 receives the image data after the image processing from the memory 16. The display image signal processing unit 13 outputs the image display data to the display unit 15.

The memory 16 stores the image data after the image processing. The memory 16 receives the image data after the image processing from the image processing unit 10. The memory 16 outputs the image data after the image processing to the display image signal processing unit 13.

The input unit 14 inputs a parameter value for prescribing an image processing algorithm used by the image processing unit 10 by a photographer, and the input parameter value is output to the control unit 8 on the main body side.

As mentioned above, the input unit 14 may be arranged to the control unit 8 on the main body side, and alternatively, the input unit 14 may be arranged to the control unit 12 on the lens unit, which will be described later. The arrangement of the input unit 14 is not limited to those.

The first communication unit 11a exchanges the filtering algorithm (image processing algorithm) to a second communication unit 11b arranged to the lens unit 5, and a communication unit 11 comprises the first communication unit 11a and the second communication unit 11b. The filtering algorithm is input to the first communication unit 11a from the second communication unit 11b. The filtering algorithm is output to the image processing unit 10 in the control unit 8 on the main body side from the first communication unit 11a.

The display unit 15 comprises an LCD (liquid crystal display), and displays the image of the subject on the basis of the image display data. The image display data is input to the display unit 15 from the display image signal processing unit 13 of the control unit 8 on the main body side.

The lens unit 5 forms the image of the subject to the image pickup device 7 with a lens system (photographing optical system) 17 included in the lens unit 5, and is detachable to the camera main body 3. As shown in FIG. 1, the lens unit 5 comprises: the lens system 17; the second communication unit 11b; the control unit 12 on the lens unit side; and the storing unit 21.

The lens system 17 forms light from the subject onto a light receiving surface of the image pickup device 7. Incidentally, according to the first embodiment, the lens system 17 does not have the optical characteristics for obtaining the special effect, such as the soft focus effect. The lens characteristics for obtaining the soft focus effect include spherical abbreviation.

Incidentally, the special effect such as the soft focus effect may be obtained with various abbreviations such as the spherical abbreviation given to the optical characteristics of the lens system 17 and image processing of the image processing unit 10. Further, various abbreviations such as the spherical abbreviation is added to the optical characteristics of the lens system 17, and the image processing of the image processing unit 10 may increase/reduce the intensity of the special effect, such as the soft focus effect, obtained by the optical characteristics.

With this structure, since the special effect is obtained with the optical characteristics of the lens system 17 without performing complicated image processing for obtaining the special effect, the calculating load of the image processing unit 10 can be reduced.

In addition, the special effect such as the soft focus effect may be obtained only by various abbreviations such as the spherical abbreviation given to the optical characteristics of the lens system 17.

Incidentally, the optical characteristics of the lens system 17 include, as examples, distortion, shading (limb darkening), and chromatic aberration of magnification.

The second communication unit 11b exchanges the filtering algorithm to the first communication unit 11a arranged to the camera main body 3, and the communication unit 11 comprises the first communication unit 11a and the second communication unit 11b. The filtering algorithm is input to the second communication unit 11b from the algorithm storing unit 21. The filtering algorithm is output to the first communication unit 11a from the second communication unit 11b.

The control unit 12 on the lens unit side controls the input/output operation of the image processing algorithm between the communication unit 11b and the algorithm storing unit 21.

The image processing algorithm is input to the control unit 12 on the lens unit side from the algorithm storing unit 21. On the other hand, the image processing algorithm is output to the communication unit 11b from the control unit 12 on the lens unit side.

Incidentally, the control unit 12 on the lens unit side may be a control unit independent on the lens unit, alternatively, may be a control unit dependent on the lens unit, and is not limited to those.

The algorithm storing unit 21 stores the filtering algorithm. The filtering algorithm is output to the second communication unit 11b from the algorithm storing unit 21. Incidentally, the filtering algorithm can include, as examples, a correction processing algorithm for correcting the optical characteristics of the lens system 17 and algorithms for creating the special effect, such as a sepia tone processing algorithm, soft focus processing algorithm, a cross-screen processing algorithm, and a mirage processing algorithm.

Next, a description will be given of the operation of the camera 1 with the above-mentioned structure and a processing method of the captured image.

Upon capturing the image of the subject with the camera 1, as shown FIG. 1, the power of the camera 1 is first turned on, thereby supplying the power to the control unit 8 on the main body side in the camera main body 3 and the control unit 12 on the lens unit side in the lens unit 5.

Thereafter, the photographer presses down a release button (not shown) of the camera 1, thereby capturing the image of the subject with the operation, which will be described hereinafter.

FIG. 2 is a flowchart for illustrating the operation of the camera shown in FIG. 1.

The release button is pressed down, thereby converting the image of the subject formed by the lens system 17 in the lens unit 5 into the image information serving as an electric signal by the image pickup device 7. The image information is input to the signal processing circuit 9 of the control unit 8 on the main body side from the image pickup device 7. The signal processing circuit 9 performs signal processing to the image information, and converts the processed image information to image data that can be processed by the image processing unit 10. The image data is input to the image processing unit 10 from the signal processing circuit 9 (in step S1).

The filtering algorithm stored in the algorithm storing unit 21 is output to the second communication unit 11b via the control unit 12 on the lens unit side, and is sent to the first communication unit 11a from the second communication unit 11b. The sent filtering algorithm is input to the image processing unit 10 in the control unit 8 on the main body side from the first communication unit 11a (in step S2).

The image processing unit 10 performs the image processing to the image data on the basis of the filtering algorithm read from the algorithm storing unit 21 (in step S3). Herein, the filtering algorithm includes the sepia tone processing algorithm, soft focus processing algorithm, cross-screen processing algorithm, and mirage processing algorithm, and the image processing of the image processing unit 10 is image processing including the filtering processing, such as the sepia tone processing.

The image data after the image processing is output to the memory 16 from the image processing unit 10, and is stored to the memory 16 (in step S4).

If the image data stored to the memory 16 is called, the image data is input from the memory 16 to the display image signal processing unit 13. The display image signal processing unit 13 converts the image data after the image processing into image display data that can be displayed on the display unit 15. The image display data is input to the display unit 15 and is stored to a cache memory. The display unit 15 displays the same image as the corrected image of the subject, stored to the cache memory and corrected (in step S5).

Incidentally, the cache memory stores the image display data on the image, other than the image that is currently displayed on the display unit 15. If the captured images are sequentially displayed on the display unit 15 in the image capturing order, the image display data on the image that is displayed next to the image currently-displayed is stored in advance to the cache memory.

Incidentally, the parameter value that prescribes a processing method in the image processing unit 10 can be changed from the input unit 14. That is, the parameter value is changed, thereby changing the degree for correcting various abbreviations and the strength of the effect of the filtering processing and the effect of retouching.

With the above-mentioned structure, since the algorithm storing unit 21 and the lens unit 5 are attached/detached to/from the camera main body 3, the algorithm storing unit 21 that stores the image processing algorithm performs predetermined image processing to the image information by selecting the lens unit 5.

Upon individually storing different image processing algorithms to the algorithm storing unit 21 of a plurality of the lens units 5, the lens unit 5 attached to the camera main body 3 is exchanged, thereby performing the image processing of the image information with different image processing algorithms. As a consequence, the images subjected to a plurality of image processing are obtained without storing a plurality of different image processing algorithms to the camera main body 3.

Further, since the lens unit 5 to be exchanged is selected to choose the image processing algorithm, this operation for selecting the image processing algorithm is easier, as compared with the method for selecting the image processing algorithm with the change-over switch arranged to the camera main body 3, and visceral or sensuous selecting operation is possible.

Upon storing the algorithm for correction processing optical characteristics peculiar to the lens system 17 to the algorithm storing unit 21, the lens unit 5 and the algorithm for correction processing of the optical characteristics peculiar to the lens system 17 are integrally attached/detached to/from the camera main body 3. Therefore, with the algorithm for correction processing of the optical characteristics peculiar to the lens system 17 used for image pickup operation, the image of the subject subjected to the image processing can be obtained. In this case, the camera main body 3 does not need to store the algorithms for correction processing of the optical characteristics peculiar to the lens system 17 of all lens units that can be attached to the camera main body 3.

Upon storing the algorithm for creating the special effect, which creates a predetermined special effect to the algorithm storing unit 21, the lens unit 5 is selected and exchanged, thereby choosing the special effect executed to the image information. Therefore, the images subjected to a plurality of different special effects can be obtained without storing a plurality of algorithms for creating the special effect to the camera main body 3.

Upon performing the same special effect due to various abbreviations using the lens system 17 to the image data, the image processing unit 10 performs the image processing for emphasizing or reducing the effects due to various abbreviations on the basis of the optical characteristics peculiar to the lens system 17, the load of the calculating processing by the image processing unit 10 can be reduced.

On the other hand, upon performing the special effect different from the effects due to various abbreviations to the image data, the image processing unit 10 removes various abbreviations on the basis of the optical characteristics peculiar to the lens system 17 and the image data is thereafter subjected to the special effect. As a consequence, the image data can be subjected to an effective special effect.

When the image data is subjected to the filtering processing as the special effect, the image processing unit 10 is exchanged together with the lens unit 5. Therefore, the selection of the lens unit results in choosing whether or not the image data is subjected to the filtering processing and in performing predetermined filtering processing to the image data.

The image processing of the image pickup data obtained by the image pickup device 7 is performed on the basis of the image processing algorithm stored in algorithm storing unit 21 of the lens unit 5 attached to the casing 3A. Therefore, upon exchanging the lens unit 5, the image processing algorithm adapted to the lens system 17 after the exchange does not need to be stored in the camera main body 3. Further, the image processing algorithm does not need to be input to the camera main body 3. Thus, the image subjected to a plurality of different image processing can be obtained without the load for storing a plurality of different image processing algorithms to the camera main body 3.

### Modification

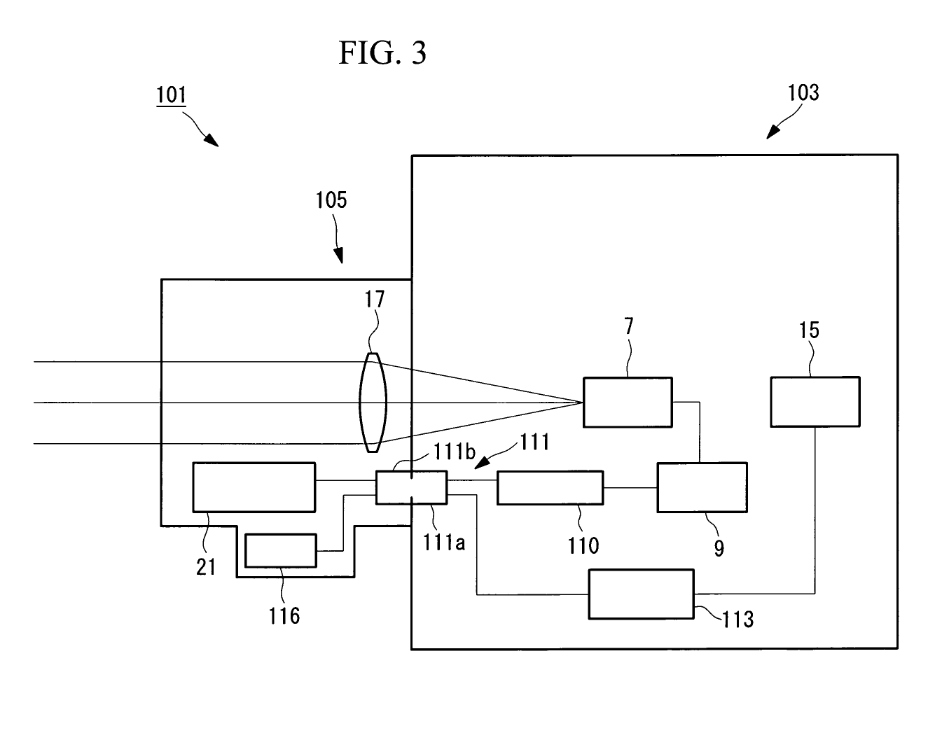

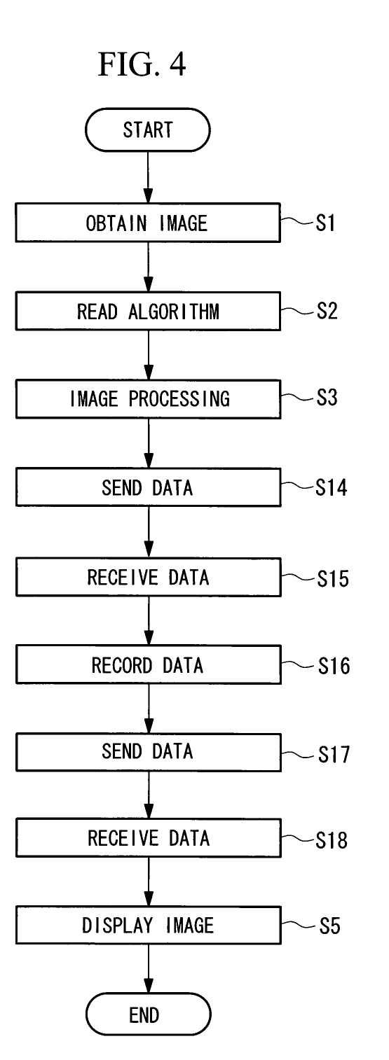

Next, a description will be given of a modification with reference to FIGS. 3 and 4.

The basic structure of the camera is similar to that shown in FIG. 1. However, the camera according to the modification is different from the camera shown in FIG. 1 in memory arrangement position. Therefore, according to the modification, only the periphery of the memory will be described with reference to FIGS. 3 and 4, and a description of other components is omitted.

FIG. 3 is a block diagram for illustrating the entire structure of the camera.

Incidentally, the same components as those in the camera shown in FIG. 1 are designated by the same reference numerals and are not described here.

A camera 101 is a digital camera that captures an image of a subject with an image pickup device such as a CCD.

Referring to FIG. 3, the camera 101 comprises a camera main body 103 and a lens unit 105.

The lens unit 105 is detachably attached to the camera main body 103. The different types of lens units 105 can be attached to the camera main body 103.

The camera main body 103 includes the image pickup device 7 that captures the image of the subject, and the lens units 105 are detachably attached to the camera main body 103. As shown in FIG. 3, the camera main body 103 comprises: the image pickup device 7; the signal processing circuit 9; an image processing unit (image processing means) 110; a first communication unit 111a; a display image signal processing unit 113; and the display unit 15.

The image processing unit 110 performs the image processing to the image data on the basis of the filtering algorithm. The image data is input to the image processing unit 110 from the signal processing circuit 9, and the filtering algorithm is input from the first communication unit 111a. The image data after the image processing is output to the first communication unit 111a from the image processing unit 110.

The first communication unit 111a exchanges the filtering algorithm (image processing algorithm) to a second communication unit 111b arranged to the lens unit 105, and the communication unit 111 comprises the first communication unit 111a and the second communication unit 111b. The filtering algorithm is input to the first communication unit 111a from the second communication unit 111b, and the image data after the image processing is input to the first communication unit 111a from the image processing unit 110. The filtering algorithm is output to the image processing unit 110 from the first communication unit 111a, and the image data after the image processing is input to the display image signal processing unit 113.

The display image signal processing unit 113 creates the image display data by signal processing of the image data after the image processing. The image data after the image processing is input to the display image signal processing unit 113 from the first communication unit 111a. The image display data is output to the display unit 15 from the display image signal processing unit 113.

The lens unit 105 forms the image of the subject to the image pickup device 7 with the lens system 17 included in the lens unit 105, and is detachably attached to the camera main body 103. As shown in FIG. 3, the lens unit 105 comprises: the lens system 17; the second communication unit 111b; the algorithm storing unit 21; and a memory 116.

The second communication unit 111b exchanges the filtering algorithm to the first communication unit 111a arranged to the camera main body 103, and the communication unit 111 comprises the second communication unit 111b and the first communication unit 111a. The filtering algorithm is input to the second communication unit 111b from the algorithm storing unit 21, and the image data after the image processing is input to the second communication unit 111b from the first communication unit 111a. The filtering algorithm is output to the first communication unit 111a from the second communication unit 111b, and the image data after the image processing is output to the memory 116.

Next, a description will be given of the operation of the camera 101 with the above-mentioned structure and a processing method of the captured image.

FIG. 4 is a flowchart for illustrating the operation of the camera shown in FIG. 3.

The operation from step S1 of capturing the image of the subject with the image pickup device 7 upon photographing the image of the subject to step S3 of image processing of the image data with the image processing unit 110 is similar to the flowchart shown in FIG. 2 and a description is therefore omitted.

The image data after the image processing is output from the image processing unit 110 to the first communication unit 111a, and is sent to the second communication unit 111b (in step S14).

The second communication unit 111b receives the image data after the image processing, sent from the first communication unit 111a (in step S15).

The image data after the image processing is input to the memory 116 from the second communication unit 111b, and is temporarily stored to the memory 116 (in step S16).

The image data after the image processing stored in the memory 116 is called and is then output from the memory 116 to the second communication unit 111b. The second communication unit 111b sends the image data after the image processing to the first communication unit 111a in the camera main body 3 (in step S17).

The first communication unit 111a receives the image data after the image processing, sent from the second communication unit 111b (in step S18).

The image data after the image processing is input to the display image signal processing unit 113 from the second communication unit 111b. The subsequent operation of the camera 101 is similar to the flowchart shown in FIG. 2, and a description thereof is omitted.

What is claimed is:

1. A camera comprising:
a camera main body;
a lens unit having an photographing optical system that forms an image of a subject;
image pickup means that captures the image of the subject and converts the captured image into electrical image information;
an algorithm storing unit that stores a predetermined image processing algorithm; and
image processing means that performs image processing of the image information on the basis of the image processing algorithm,
wherein the algorithm storing unit is arranged to the lens unit, and
the lens unit and the algorithm storing unit are detachably attached to the camera main body.

2. The camera according to claim 1, wherein the algorithm storing unit stores image processing algorithm peculiar to the lens unit.

3. The camera according to claim 1, wherein the algorithm storing unit stores an algorithm that performs correction processing of optical characteristics peculiar to the photographing optical system.

4. The camera according to claim 1, wherein the algorithm storing unit stores an algorithm for creating a special effect that creates the special effect.

5. The camera according to claim 4, wherein the image pickup processing means performs the image processing by using information on the optical characteristics peculiar to the photographing optical system of the lens unit.

6. The camera according to claim 5, wherein a predetermined abbreviation is given to the optical characteristics of the photographing optical system.

7. The camera according to claim 4, wherein the special effect is obtained by filtering processing.

8. A lens unit that is detachably attached to a camera main body, comprising:
a photographing optical system that forms an image of a subject to image pickup means arranged to the camera main body; and
an algorithm storing unit that stores a predetermined image processing algorithm used for image processing of image information obtained by the image pickup means.

9. The lens unit according to claim 8, wherein the predetermined image processing algorithm is a filtering algorithm.

10. A camera main body comprising:
a casing; and
image pickup means that captures an image of a subject and converts the image into electrical image information,
wherein the lens unit according to claim 8 or 9 is detachably attached to the casing.
